(19) United States
(12) Patent Application Publication
(10) Pub. No.: US 2025/0061414 A1
(43) Pub. Date: Feb. 20, 2025

(54) SYSTEMS AND METHODS FOR FACILITATING INVENTORY MANAGEMENT

(71) Applicant: Ford Global Technologies, LLC, Dearborn, MI (US)

(72) Inventors: Geoffrey Horowitz, Birmingham, MI (US); Sarah Garrow, Coral Gables, FL (US); Meghna Menon, Ann Arbor, MI (US); John Randolf Vincent, Livonia, MI (US); Jason Snow, Ferndale, MI (US)

(73) Assignee: Ford Global Technologies, LLC, Dearborn, MI (US)

(21) Appl. No.: 18/451,240

(22) Filed: Aug. 17, 2023

(51) Int. Cl. G06Q 10/087; B65G 67/24; G06Q 10/0833

(52) U.S. Cl. CPC G06Q 10/087; B65G 67/24; G06Q 10/0833

(57) ABSTRACT

A vehicle including a transceiver, a control unit and a processor is disclosed. The transceiver may be configured to receive inventory information from a server. The inventory information may include a plurality of delivery addresses associated with a plurality of packages disposed in the vehicle. The control unit may be configured to determine vehicle information. The processor may be configured to determine that a predefined condition may be met based on the inventory information and the vehicle information. The processor may further generate a geofence for each delivery address based on the vehicle information, responsive to determining that the predefined condition may be met. Furthermore, the processor may determine that the vehicle may have entered the geofence based on the vehicle information. The processor may perform a predefined action responsive to determining that the vehicle may have entered the geofence.

### FIELD

The present disclosure relates to systems and methods for facilitating inventory management in a delivery vehicle.

### BACKGROUND

With the continued growth of internet-based commerce, package delivery is increasingly used to deliver goods to customers. Specifically in the US, e-commerce business is expected to continue to grow in the years to come.

Unprecedented growth is received favorably by e-commerce companies. However, the rapid growth also leads to operational challenges in the supply chain. E-commerce companies and their delivery partners deliver an ever-increasing number of packages per day, while trying to limit spend on resources (e.g., labor, etc.) and reduce delivery time.

Various approaches are currently used to optimize the process of loading/unloading delivery packages to/from a delivery vehicle, and the process of delivering packages to respective delivery locations. For example, E-commerce companies load packages with similar delivery addresses in proximity to each other in a delivery vehicle to gain efficiency in unloading packages. Further, E-commerce companies use centralized inventory management systems or servers to monitor movement of their delivery vehicles, and control unloading of packages remotely from the servers to gain efficiency and reduce chances of human error during unloading operation.

While conventional methods performed by the E-commerce companies are effective in gaining efficiency, there remain challenges that cause inconvenience to vehicle drivers and/or the E-commerce companies. For example, loading/unloading of delivery packages to/from a delivery vehicle in a warehouse is still a manual process, and hence requires resources that may be unavailable or expensive. Furthermore, delivery of packages may get affected if connectivity to the centralized inventory management server is lost for a delivery vehicle, which may result in loss of efficiency in delivering packages.

Thus, there exists a need for a system and method that facilitates loading/unloading of packages in/from a delivery vehicle, and enables package delivery even when the connection with the centralized inventory management server is lost.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example system for managing inventory in accordance with the present disclosure.

FIG. 3 depicts a view of an example warehouse in accordance with the present disclosure.

FIG. 4 depicts an example view of a delivery vehicle deviating from a preset delivery route in accordance with the present disclosure.

FIG. 5A depicts an example view of a plurality of delivery locations in a geographical area in accordance with the present disclosure.

FIG. 5B depicts first example geometries of a plurality of geofences in accordance with the present disclosure.

FIG. 5C depicts second example geometries of a plurality of geofences in accordance with the present disclosure.

FIG. 6 depicts third example geometries of a plurality of geofences in accordance with the present disclosure.

FIG. 7 depicts a view of a plurality of clusters of geofences in a geographical area in accordance with the present disclosure.

FIG. 8 depicts a flow diagram of an example method for facilitating delivery of a plurality of packages stored in a delivery vehicle in accordance with the present disclosure.

### DETAILED DESCRIPTION

### Overview

The present disclosure describes a delivery vehicle configured to deliver a plurality of packages to respective delivery locations. The vehicle may be communicatively coupled with an inventory management unit and an infrastructure marshalling system. The inventory management unit may be configured to determine optimum storage locations for the plurality of packages in a plurality of bins disposed in the vehicle, and optimum preset delivery route/sequence of package delivery, based on one or more parameters such as package delivery addresses, weight and size, bin size and location in the vehicle, and/or the like. The inventory management unit may store this determined “inventory information” in an inventory management unit memory, and may also transmit the inventory information to the vehicle (e.g., to a vehicle memory) for local storage and the infrastructure marshalling system.

In some aspects, the infrastructure marshalling system may be associated with a warehouse or facility that may load the plurality of packages in the vehicle, based on the inventory information. Specifically, responsive to receiving the inventory information from the inventory management unit, the infrastructure marshalling system may determine an optimum loading point in the warehouse for the vehicle, based on the inventory information and vehicle dimensions (e.g., vehicle size, vehicle loading point type, and/or the like).

Responsive to receiving the inventory information from the inventory management unit, the vehicle may reach the warehouse. When the vehicle reaches the warehouse, the infrastructure marshalling system may automatically marshal the vehicle to the determined optimum loading point, and may load the plurality of packages in the vehicle based on the inventory information. Responsive to the packages being loaded, the vehicle may commence the traversing the delivery route.

When the vehicle may be travelling on the delivery route, the inventory management unit may continuously control vehicle movement and bin/package movement within the vehicle. For example, when a package scheduled to be delivered may be in proximity to its delivery address, the inventory management unit may remotely activate a package mover unit in the vehicle and cause the respective bin/package to automatically move from its storage location in the vehicle to a package unloading area. The package unloading area may be an area or portion in the vehicle from where a vehicle operator or a robot/drone may conveniently pick the package to be delivered. Responsive to the package being delivered, the inventory management unit may update the inventory information to mark the package as “delivered”. The inventory management unit may further transmit the updated inventory information to the vehicle for local storage in the vehicle.

In some aspects, a vehicle processor may “takeover” inventory management unit operation when a vehicle connection with the inventory management unit may be lost and/or when the vehicle deviates from its preset delivery route. In this case, the vehicle processor may fetch the inventory information from the vehicle memory, and may control bin/package movement based on the inventory information and vehicle information including real-time vehicle geolocation, vehicle speed, and/or the like. Specifically, the vehicle processor may generate “geofences” around each delivery address, and may activate the package mover unit to move respective bin/package to the package unloading area when the vehicle enters a geofence. In some aspects, the vehicle processor generates the geofences based on average or real-time vehicle speed, distances between delivery addresses associated with the plurality of packages, average or expected time duration required by the package mover unit to move the bins/packages to the package unloading area, and/or the like.

As and when the packages may be delivered, the vehicle processor may track delivery status of each package by using vehicle interior cameras, and may update the inventory information. The vehicle processor may further store the updated inventory information in the vehicle memory. When the vehicle connection with the inventory management unit may be restored, the vehicle processor may transmit the updated inventory information to the inventory management unit, so that the inventory management unit may again take over control of bin/package movement remotely. In this manner, the vehicle processor ensures that package delivery happens efficiently and optimally, even when the vehicle connection with the inventory management unit may be lost.

In further aspects, when the vehicle finishes the delivery route, the vehicle may return to the warehouse to unload the undelivered packages. Responsive to the vehicle reaching the warehouse, the infrastructure marshalling system may determine an optimum unloading point for the vehicle, and may automatically marshal the vehicle to the unloading point and unload the undelivered packages.

The present disclosure discloses a system to enable efficient delivery of packages even when the vehicle connection with the central inventory management unit may be lost. Further, the infrastructure marshalling system enables automatic and optimum loading and unloading of packages to/from the vehicle, thereby reducing human involvement in loading/unloading operation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

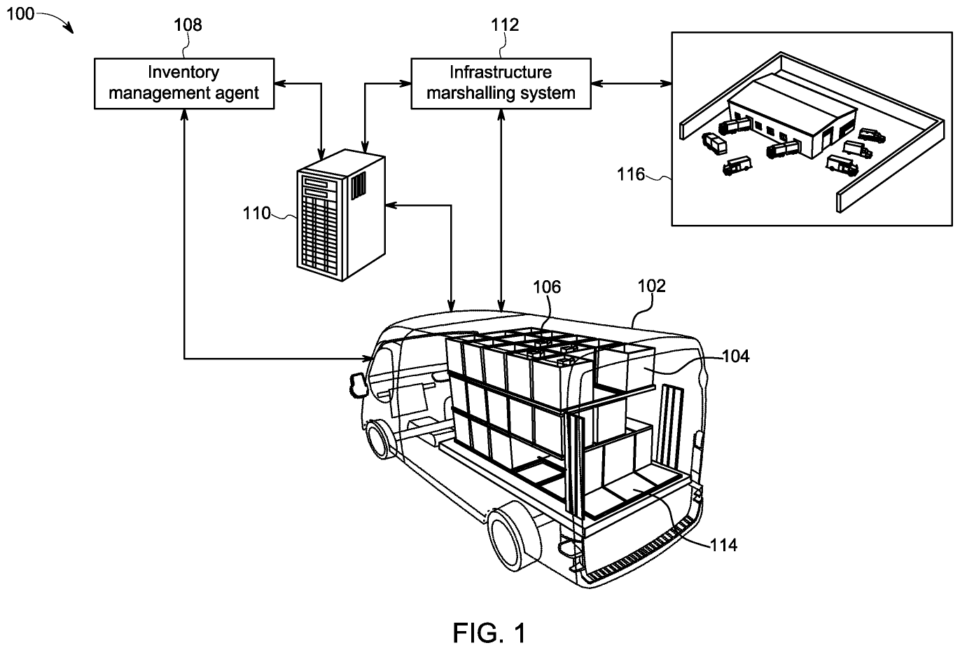

FIG. 1 depicts an example environment 100 in which techniques and structures for providing the systems and methods disclosed herein may be implemented. The environment 100 may include a delivery vehicle 102 (or vehicle 102) that may be a truck, a van (including walk-in vans), a truck trailer, and/or the like. In some aspects, the vehicle 102 may be an autonomous vehicle. In other aspects, a driver (not shown) may operate the vehicle 102. Further, the vehicle 102 may include any powertrain such as, for example, a gasoline engine, one or more electrically-actuated motor(s), a hybrid system, etc.

The vehicle 102 may include a plurality of bins 104 that may be disposed in a vehicle interior portion. The plurality of bins 104 may be disposed in any arrangement in the vehicle interior portion. For example, the plurality of bins 104 may be placed in one or more arrays, and each array may be disposed one over the other (as shown in FIG. 1), or placed on a cabin bed or one or more trays disposed on vehicle sidewalls, and/or the like. The exemplary arrangement of the plurality of bins 104 depicted in FIG. 1 should not be construed as limiting.

Each bin 104 may be configured to store/hold one or more delivery packages 106 (or packages 106). Each package 106 may be associated with customer information and a delivery address to which the package 106 may be required to be delivered by the vehicle 102. In an exemplary aspect, each package 106 may include an identifier or a tag (e.g., April tag, not shown) that may be disposed on the package 106, which may include the customer information and the delivery address. A sensor (e.g., a vehicle camera) or a reader may scan the tag on the package 106, and determine the corresponding customer information and the delivery address. The vehicle 102 may use the customer information and the delivery address to deliver the package 106 efficiently and correctly to its delivery/destination address and/or to monitor delivery status (e.g., successful delivery or unsuccessful delivery) for the package 106, as described later below.

The vehicle 102 may be communicatively connected with an inventory management agent or unit 108, a cloud storage or server 110 and an infrastructure marshalling system 112. The server 110 may be associated with an E-commerce firm and/or the firm's delivery partner, and may be configured to store information associated with a plurality of delivery packages (including the packages 106) that are required to be delivered to respective delivery addresses. The information associated with the plurality of delivery packages may include, but is not limited to, customer names, contact details, delivery addresses, package sizes, package weights, any special delivery instructions, priority order of deliveries, and/or the like.

The inventory management unit 108 may be part of the server 110 or may be separate from the server 110 (as shown in FIG. 1), and may be configured to obtain the information associated with the plurality of delivery packages from the server 110. Responsive to obtaining the information, the inventory management unit 108 may execute inventory optimization algorithms (that may be stored in an inventory management unit memory, not shown) to determine optimum distribution/assignment of the plurality of packages in a plurality of delivery vehicles (including the vehicle 102) and an optimum preset delivery route for each vehicle. In some aspects, the inventory management unit 108 may assign the plurality of packages to the plurality of delivery vehicles such that packages with similar delivery addresses may be assigned to a single delivery vehicle, or packages with greater sizes are assigned to larger vehicles, and/or the like. In some aspects, the inventory management unit 108 may assign the plurality of packages to the plurality of delivery vehicles to optimize overall energy consumption of the plurality of delivery vehicles and minimize delivery time.

In an exemplary aspect, the inventory management unit 108 may additionally determine an optimum bin location for each package within a delivery vehicle, so that package retrieval from the bins may be convenient when the delivery vehicle reaches respective delivery locations. For example, a package with a first delivery location on a delivery route may be disposed in a bin that may be closest to a package unloading area 114 of the vehicle 102. In some aspects, the package unloading area 114 may be an area/portion in the vehicle 102 from where a user or a robot/drone may conveniently pick the package to be delivered.

Responsive to assigning the plurality of packages to the plurality of delivery vehicles, and assigning bin location to each package, the inventory management unit 108 may send this “assignment information” described above to the server 110 for storage purpose. The inventory management unit 108 may additionally transmit the assignment information to an automated loader (e.g., a robot, not shown) and/or the infrastructure marshalling system 112 to enable the plurality of packages to be automatically loaded into the plurality of delivery vehicles based on the assignment information.

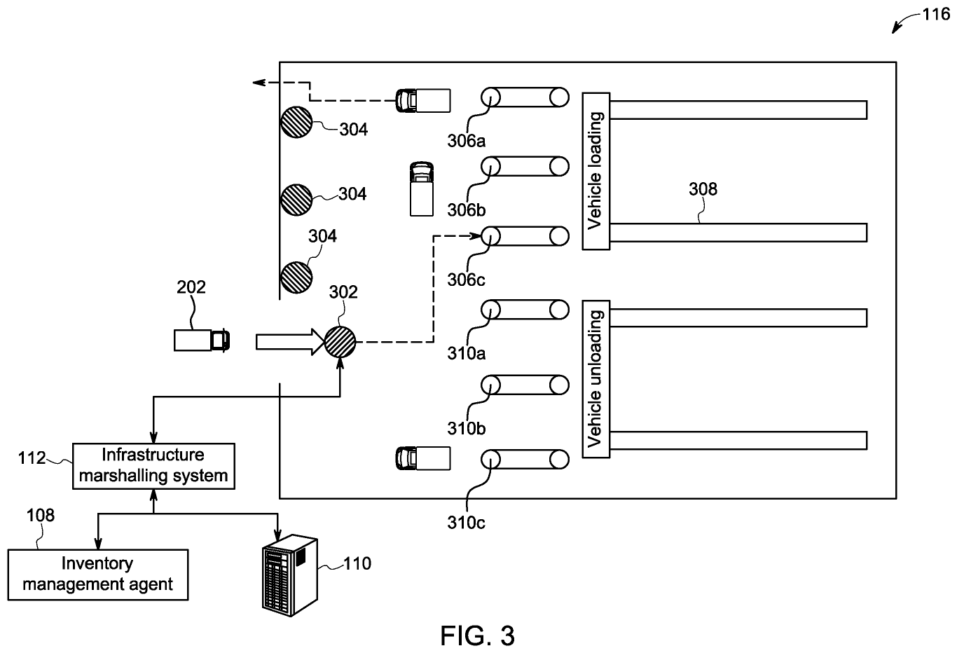

In some aspects, responsive to obtaining the assignment information, the infrastructure marshalling system 112 may load the packages 106 to the vehicle 102 based on the assignment information. Specifically, the infrastructure marshalling system 112 may automatically “marshal” or move the vehicle 102 to a designated loading point in a facility or warehouse 116 based on one or more parameters, and load the packages 106 to the allocated bins 104 in the vehicle 102. Examples of the parameters include, but are not limited to, vehicle bin sizes, vehicle bin loading/unloading height above ground level, sizes, and types of packages to be loaded in the vehicle 102 (determined based on the assignment information), vehicle loading point type (e.g., whether the vehicle 102 is to be loaded from a vehicle side portion or a vehicle rear portion), and/or the like. In some aspects, the infrastructure marshalling system 112 may be associated with the warehouse or facility 116, and may be configured to efficiently load (and unload) the plurality of packages to (from) the plurality of delivery vehicles. In some aspects, the warehouse 116 may be associated with the E-commerce firm/delivery partner described above, and may store the plurality of packages when the packages are not loaded on the plurality of delivery vehicles. The details of the warehouse 116 and the infrastructure marshalling system 112 are described later in the description below in conjunction with FIG. 3.

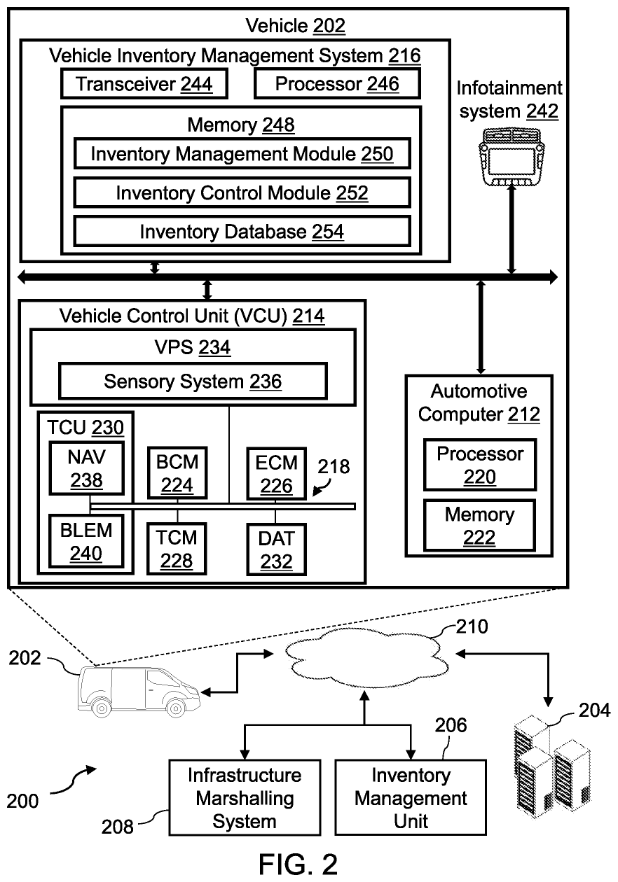

Responsive to the packages 106 being loaded in the vehicle 102, the vehicle 102 may obtain (or download) a copy of the assignment information associated with the packages 106 loaded in the vehicle 102 (or “inventory information” associated with the packages 106) from the server 110 and/or the inventory management unit 108. In some aspects, the inventory information may include delivery address, package size, package weight, bin location, special delivery instructions, customer details, and/or the like, associated with each package 106. In some aspects, the inventory information may further include an optimum preset delivery route for the vehicle 102, as determined by the inventory management unit 108. The vehicle 102 may store the inventory information in a vehicle memory (shown as memory 248 in FIG. 2), responsive to obtaining the inventory information from the server 110 and/or the inventory management unit 108.

Further, responsive to the packages 106 being loaded in the vehicle 102 and the vehicle 102 storing the inventory information in the vehicle memory, the vehicle 102 may commence traversing the preset delivery route. While in transit, the inventory management unit 108 may be communicatively coupled with the vehicle 102, and may control bin movement within the vehicle 102, and movement of a particular package/bin to the package unloading area 114 when the particular package is to be delivered (e.g., when the vehicle 102 reaches the delivery location associated with the particular package).

In some aspects, the inventory management unit 108 may continuously determine vehicle geolocation (e.g., via a Global Positioning System, not shown) when the vehicle 102 may be travelling on the delivery route, and may control package/bin movement based on the vehicle geolocation. In an exemplary aspect, the inventory management unit 108 may trigger movement of a particular package/bin (e.g., the package 106) to the package unloading area 114 when the vehicle 102 enters a “geofence” or a geographical area in proximity to the delivery location associated with the package 106. In some aspects, the geofence may be a circle of a fixed radius that may be formed on a digital map around the delivery location associated with the package 106. The inventory management unit 108 may trigger or initiate movement of the bin storing the package 106 to the package unloading area 114 when the vehicle 102 enters the geofence “circle”. The concept of geofence is described in detail later in conjunction with FIG. 2 and FIGS. 5-7.

The inventory management unit 108 may continuously update the inventory information, including locations of the bins 104 (that may be moved during transit) within the vehicle 102, when one or more packages 106 may be delivered by the vehicle 102. The updated inventory information may include updated bin locations within the vehicle 102, delivery status of each package 106 (successfully delivered, yet to be delivered, unsuccessful or unclaimed deliveries, etc.), and/or the like. The inventory management unit 108 may transmit the updated inventory information at a predefined frequency to the server 110 and/or the vehicle 102 for storage purpose.

In a scenario where a vehicle connection with the inventory management unit 108 is lost (e.g., when the vehicle 102 may be in a geographical area with no communication/network connectivity) and/or when the vehicle 102 deviates from the preset delivery route, the vehicle 102 may “take over” the operation or function that the inventory management unit 108 was performing on the vehicle 102, and may manage bin/package movement and package delivery based on the stored (updated) inventory information. In this case, a vehicle processor (shown as processor 246 in FIG. 2) may obtain the inventory information stored in the vehicle memory, and may control bin movement within the vehicle 102 based on real-time vehicle geolocation and the inventory information. The vehicle processor may further generate geofences on the digital map around the delivery locations associated with the packages stored in the vehicle 102, based on average or real-time vehicle speed and delivery addresses of respective packages. The vehicle processor may further trigger package/bin movement for a particular package/bin, when the vehicle 102 enters one or more geofences, as briefly described above and described in detail later below in conjunction with FIG. 2 and FIGS. 5-7.

The vehicle processor may further use one or more vehicle interior cameras to capture images of tags (e.g., April tags) disposed on the packages 106, and track package deliveries based on the captured images. For example, when a particular package may be moved to the package unloading area 114 and picked by a vehicle driver or a robot/drone for delivery, the cameras may capture images of the tag disposed on the package. The vehicle processor may then “read” the tag based on the captured images and determine that the package may be delivered. Responsive to determining that the package may be delivered, the vehicle processor may update the inventory information and store the updated inventory information in the vehicle memory. In this manner, as and when the packages 106 may be delivered, the vehicle processor may update and store the inventory information in the vehicle memory, till the vehicle connection with the inventory management unit 108 may be restored. Responsive to the vehicle connection with the inventory management unit 108 being restored, the vehicle 102 may transmit the “updated” inventory information from the vehicle memory to the inventory management unit 108 (and/or the server 110). The inventory management unit 108 may then take over package delivery/movement operation of the vehicle 102 based on the updated inventory information. In this manner, the vehicle 102 continues to optimally and efficiently deliver the packages 106 to respective delivery addresses even when the vehicle connection with the inventory management unit 108 may be lost, and may transmit or “handover” updated inventory information to the inventory management unit 108 when the vehicle connection may be restored, thus enabling smooth and seamless inventory delivery management.

In further aspects, when the vehicle 102 finishes the delivery route, the vehicle 102 reach the warehouse 116 where the infrastructure marshalling system 112 may automatically detect vehicle arrival, and may marshal the vehicle 102 to an optimum loading/unloading point in the warehouse 116. In some aspects, the vehicle 102 may visit the warehouse 116 to unload undelivered packages, load new delivery packages, get charged (e.g., via Electric Vehicle (EV) charging stations disposed in the warehouse 116), and/or the like. As briefly described above and described in detail later below, the infrastructure marshalling system 112 may marshal the vehicle 102 based on vehicle bin sizes, vehicle bin loading/unloading height above ground level, sizes, and types of packages to be loaded in/unloaded from the vehicle 102, vehicle loading point type, and/or the like.

Further details of the vehicle 102 are described below in conjunction with FIG. 2.

The vehicle 102, the inventory management unit 108, the server 110 and/or the infrastructure marshalling system 112 implement and/or perform operations, as described here in the present disclosure, in accordance with the owner manual and safety guidelines.

FIG. 2 depicts a block diagram of an example system 200 for managing inventory in accordance with the present disclosure. In some aspects, the inventory may include one or more packages 106 described above in conjunction with FIG. 1. While describing FIG. 2, references may be made to FIGS. 3-7.

The system 200 may include a vehicle 202, one or more servers 204, an inventory management unit 206, an infrastructure marshalling system 208 communicatively coupled with each other via one or more networks 210. The vehicle 202 may be same as the vehicle 102 described above in conjunction with FIG. 1. Further, the inventory management unit 206 may be same as the inventory management unit 108, the infrastructure marshalling system 208 may be same as the infrastructure marshalling system 112 and the server(s) 204 may be same as the server 110.

The network(s) 210 illustrates an example communication infrastructure in which the connected devices discussed in various embodiments of this disclosure may communicate. The network(s) 210 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 202 may include a plurality of units including, but not limited to, an automotive computer 212, a Vehicle Control Unit (VCU) 214, and a vehicle inventory management system 216. The VCU 214 may include a plurality of Electronic Control Units (ECUs) 218 disposed in communication with the automotive computer 212.

In some aspects, the automotive computer 212 and/or the vehicle inventory management system 216 may be installed anywhere in the vehicle 202 in accordance with the disclosure. Further, the automotive computer 212 may operate as a functional part of the vehicle inventory management system 216. The automotive computer 212 may be or include an electronic vehicle controller, having one or more processor(s) 220 and a memory 222. Moreover, the vehicle inventory management system 216 may be separate from the automotive computer 212 (as shown in FIG. 2) or may be integrated as part of the automotive computer 212.

The processor(s) 220 may be disposed in communication with one or more memory devices disposed in communication with the respective computing systems (e.g., the memory 222 and/or one or more external databases not shown in FIG. 2). The processor(s) 220 may utilize the memory 222 to store programs in code and/or to store data for performing aspects in accordance with the disclosure. The memory 222 may be a non-transitory computer-readable storage medium or memory storing delivery package management program code or instructions. The memory 222 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 214 may share a power bus with the automotive computer 212 and may be configured and/or programmed to coordinate the data between vehicle systems, connected servers/systems (e.g., the server(s) 204, the inventory management unit 206, the infrastructure marshalling system 208, etc.), and other vehicles (not shown in FIG. 2) operating as part of a vehicle fleet. The VCU 214 can include or communicate with any combination of the ECUs 218, such as, for example, a Body Control Module (BCM) 224, an Engine Control Module (ECM) 226, a Transmission Control Module (TCM) 228, a telematics control unit (TCU) 230, a Driver Assistances Technologies (DAT) controller 232, etc. The VCU 214 may further include and/or communicate with a Vehicle Perception System (VPS) 234, having connectivity with and/or control of one or more vehicle sensory system(s) 236. The vehicle sensory system 236 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (LiDAR or “lidar”) sensor, door sensors, proximity sensors, temperature sensors, wheel sensors, ambient weather sensors, vehicle interior and exterior cameras, steering wheel sensors, etc. In an exemplary aspect, the vehicle interior camera(s) may be configured to capture images of tags (e.g., April tags) disposed on the packages 106 when the packages 106 may be moved to the package unloading area 114 and delivered to respective delivery locations, as described above in conjunction with FIG. 1.

In some aspects, the VCU 214 may control vehicle operational aspects and implement one or more instruction sets received from the server(s) 204, the inventory management unit 206, the infrastructure marshalling system 208, from one or more instruction sets stored in the memory 222, instructions operational as part of the vehicle inventory management system 216, and/or the like.

The TCU 230 may be configured and/or programmed to provide vehicle connectivity to wireless computing systems onboard and off board the vehicle 202, and may include a Navigation (NAV) receiver 238 for receiving and processing a GPS signal, a BLE® Module (BLEM) 240, a Wi-Fi transceiver, a UWB transceiver, and/or other wireless transceivers (not shown in FIG. 2) that may be configurable for wireless communication (including cellular communication) between the vehicle 202 and other systems (e.g., a vehicle key fob, not shown in FIG. 2), computers, and modules. The TCU 230 may be disposed in communication with the ECUs 218 by way of a bus. In some aspects, the TCU 230, via the NAV receiver 238, may be configured to determined real-time vehicle geolocation.

The ECUs 218 may control aspects of vehicle operation and communication using inputs from human drivers, inputs from an autonomous vehicle controller, the vehicle inventory management system 216, and/or via wireless signal inputs received via the wireless connection(s) from other connected devices/systems, such as the server(s) 204, the inventory management unit 206, the infrastructure marshalling system 208, among others.

The BCM 224 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, wipers, door locks and access control, and various comfort controls. The BCM 224 may also operate as a gateway for bus and network interfaces to interact with remote ECUs (not shown in FIG. 2). In some aspects, the BCM 224 may additionally enable and control bin movement within the vehicle 202 based on inputs received from the inventory management unit 206, the infrastructure marshalling system 208, and/or the vehicle inventory management system 216.

The DAT controller 232 may provide Level-1 through Level-3 automated driving and driver assistance functionality that can include, for example, active parking assistance, vehicle backup assistance, adaptive cruise control, and/or lane keeping, among other features. The DAT controller 232 may also provide aspects of user and environmental inputs usable for user authentication. In further aspects, the DAT controller 232 may be configured to control vehicle movement within the warehouse 116 based on inputs received from the infrastructure marshalling system 208.

In some aspects, the automotive computer 212 may connect with an infotainment system 242. The infotainment system 242 may include a touchscreen interface portion, and may include voice recognition features, biometric identification capabilities that can identify users based on facial recognition, voice recognition, fingerprint identification, or other biological identification means. In other aspects, the infotainment system 242 may be further configured to receive user instructions via the touchscreen interface portion, and/or display notifications (including delivery status, delivery locations, special instructions, etc. associated with the packages 106), navigation maps, etc. on the touchscreen interface portion.

The computing system architecture of the automotive computer 212, the VCU 214, and/or the vehicle inventory management system 216 may omit certain computing modules. It should be readily understood that the computing environment depicted in FIG. 2 is an example of a possible implementation according to the present disclosure, and thus, it should not be considered limiting or exclusive.

In accordance with some aspects, the vehicle inventory management system 216 may be integrated with and/or executed as part of the ECUs 218. The vehicle inventory management system 216, regardless of whether it is integrated with the automotive computer 212 or the ECUs 218, or whether it operates as an independent computing system in the vehicle 202, may include a transceiver 244, a controller or processor 246, and a computer-readable memory 248.

The transceiver 244 may be configured to receive information/inputs (e.g., the inventory information described above) from one or more external devices or systems, e.g., the server(s) 204, the inventory management unit 206, the infrastructure marshalling system 208, and/or the like via the network 210. Further, the transceiver 244 may transmit notifications/information (e.g., updated inventory information) to the external devices or systems. In addition, the transceiver 244 may be configured to receive information/inputs from vehicle components such as the infotainment system 242, the VCU 214, and/or the like. Further, the transceiver 244 may transmit signals (e.g., command signals) or notifications to the vehicle components such as the infotainment system 242, the VCU 214, etc.

The processor 246 and the memory 248 may be same as or similar to the processor 220 and the memory 222, respectively. In some aspects, the processor 246 may utilize the memory 248 to store programs in code and/or to store data for performing aspects in accordance with the disclosure. The memory 248 may be a non-transitory computer-readable storage medium or memory storing the delivery package management program code. In some aspects, the memory 248 may additionally store information associated with the vehicle 202, inputs or information obtained from the server(s) 204, the inventory management unit 206 and the infrastructure marshalling system 208, and one or more inputs received from the VCU 214. The memory 248 may include a plurality of modules and databases including, but not limited to, an inventory management module 250 (or an “inventory manager”), an inventory control module 252, an inventory database 254, and/or the like.

The inventory database 254 may be configured to store the inventory information described above in conjunction with FIG. 1. For example, the inventory database 254 may store delivery address, package size, package weight, bin location of each bin in the vehicle 202, special delivery instructions, customer details, and/or the like, associated with each package. The inventory management module 250 and the inventory control module 252, as described herein, may be stored in the form of computer-executable instructions, and the processor 246 may be configured and/or programmed to execute the stored computer-executable instructions for performing operations as described here in the present disclosure. In some aspects, the processor 246 may execute the instructions stored in the inventory management module 250 to monitor movement of bins/packages in the vehicle 202 and accordingly update the inventory database 254. Further, the processor 246 may execute the instructions stored in the inventory control module 252 to control or cause movement of bins/packages in the vehicle 202, cause activation and control operation of one of more vehicle components, e.g., vehicle cameras, and/or the like.

In operation, the transceiver 244 may receive the inventory information associated with the packages 106 to be loaded in the vehicle 202 from the inventory management unit 206 or the server(s) 204, as described above in conjunction with FIG. 1. The inventory information may include, for example, a delivery address of each package 106, storage information or location of each package 106 in the bins 104, location of each bin 104 in the vehicle 202, a preset travel route or delivery route (as determined by the inventory management unit 206) for the vehicle 202 to optimally deliver the packages 106, package dimensions/size and weight information associated with each package 106, and/or the like. Responsive to receiving the inventory information, the transceiver 244 may send the received information to the inventory database 254for storage purpose.

In some aspects, the inventory management unit 206 or the server(s) 204 may also transmit the inventory information, along with vehicle associated dimension information, to the infrastructure marshalling system 208. The vehicle associated dimension information may include, for example, vehicle dimensions, sizes of the bins 104 in the vehicle 202, information associated with vehicle loading point (e.g., whether the packages 106 may be loaded in the vehicle 202 from a vehicle rear portion or a vehicle side portion), bin loading/unloading height above ground level, and/or the like.

Responsive to receiving the inventory information, the vehicle 202 may reach the warehouse 116, where the infrastructure marshalling system 208 may marshal the vehicle 202 to an optimum package loading point, identified based on the inventory information and the vehicle associated dimension information, as depicted in FIG. 3. Specifically, as shown in FIG. 3, when the vehicle 202 reaches an onboarding point 302, the infrastructure marshalling system 208 may determine vehicle presence in the warehouse 116 by using images captured by warehouse cameras (not shown) or one or more sensors disposed in the warehouse 116. In additional aspects, the infrastructure marshalling system 208 may determine the vehicle presence in the warehouse 116 based on the real-time vehicle geolocation that the vehicle 202 may transmit directly to the infrastructure marshalling system 208, or via the inventory management unit 206. In this case, the transceiver 244 may obtain the real-time vehicle geolocation from the NAV receiver 238, and may transmit the real-time vehicle geolocation to the infrastructure marshalling system 208 and/or the inventory management unit 206.

Responsive to determining the vehicle presence in the warehouse 116, the infrastructure marshalling system 208 may request vehicle battery state of charge (SoC) information directly from the vehicle 202 or via the inventory management unit 206. The transceiver 244 may receive the request from the infrastructure marshalling system 208, and may obtain the battery SoC from the VCU 214 responsive to receiving the request. The transceiver 244 may further transmit the battery SoC directly to the infrastructure marshalling system 208 or via the inventory management unit 206.

Responsive to obtaining the battery SoC, the infrastructure marshalling system 208 may determine whether the battery SoC may be below a predefined SoC threshold (that may be pre-stored in an infrastructure marshalling system memory, not shown). The infrastructure marshalling system 208 may marshal the vehicle 202, by transmitting a command signal to the DAT controller 232, to an available charging station 304 responsive to determining that the battery SoC may be below the predefined SoC threshold. The vehicle battery may then get charged at the charging station 304.

On the other hand, responsive to determining that the battery SoC may be greater than the predefined SoC threshold (or when the vehicle battery gets charged at the charging station 304), the infrastructure marshalling system 208 may determine an optimum (and available) package loading point 306a, 306b or 306c for the vehicle 202 based on the inventory information and the vehicle associated dimension information. For example, if the vehicle 202 may be small-sized and may be loaded from the vehicle rear portion, the infrastructure marshalling system 208 may determine the loading point 306a as the optimum loading point for the vehicle 202. Similarly, if the vehicle 202 may be small-sized and may be loaded from the vehicle side portion, the infrastructure marshalling system 208 may determine the loading point 306b as the optimum loading point for the vehicle 202. Further, if the vehicle 202 may be large-sized and may be loaded from the vehicle rear portion, the infrastructure marshalling system 208 may determine the loading point 306c as the optimum loading point for the vehicle 202 (as depicted in FIG. 3).

Responsive to determining the loading point 306c for the vehicle 202, the infrastructure marshalling system 208 may transmit a command signal to the DAT controller 232 to cause the vehicle 202 to automatically move towards the loading point 306c. Responsive to the vehicle 202 reaching the loading point 306c, the infrastructure marshalling system 208 may automatically load the vehicle 202/bins 104 with the packages 106 based on the inventory information, via robots and/or conveyor lanes 308. In this manner, the infrastructure marshalling system 208 may automatically marshal the vehicle 202 in the warehouse 116 and load the packages 106 in the bins 104, with no or minimal human intervention, thus saving resources and preventing chances of human error.

When the packages 106 may be loaded in the bins 104, the vehicle 202 may commence travel on the preset delivery route, based on inputs/commands received by the transceiver 244 from the inventory management unit 206. While in transit, the transceiver 244 may continuously (or at a predefined frequency) receive vehicle information from the VCU 214, and may transmit the vehicle information to the inventory management unit 206 and the processor 246. The vehicle information may include, for example, the real-time vehicle geolocation (as determined by the NAV receiver 238), a vehicle speed, a connection status of the vehicle 202/VCU 214 with the inventory management unit 206 and/or the server(s) 204, and/or the like.

The inventory management unit 206 may control the vehicle 202 and/or bin 104 movement based on the inventory information and the received vehicle information. For example, the inventory management unit 206 may trigger movement of a bin storing a particular package towards the package unloading area 114 when the vehicle 202 is about to reach or is in proximity to the delivery location associated with the package, as determined using the real-time vehicle geolocation. Responsive to the vehicle 202 reaching the delivery location and the package being picked from the package unloading area 114 by a vehicle operator or a robot/drone, the inventory management unit 206 may update the inventory information. Specifically, the inventory management unit 206 may update the inventory information to record the package as “delivered”, and may store the updated inventory information in an inventory management unit memory (not shown). The inventory management unit 206 may additionally transmit the updated inventory information to the transceiver 244, so that the transceiver 244 may send the updated inventory information to the inventory database 254 for local storage of the updated inventory information in the vehicle 202. In this manner, the inventory management unit 206 may continue to control vehicle and bin movement through the preset delivery route and continuously update the inventory information and transmit the updated inventory information to the transceiver 244 for local storage in the vehicle 202.

The processor 246 may continuously (or at a predefined frequency) monitor, by executing the instructions stored in the inventory management module 250, the inventory information stored in the inventory database 254 and the vehicle information obtained from the VCU 214/transceiver 244. The processor 246 may initiate or trigger a “geofence” mode of vehicle operation when the processor 246 determines that a predefined condition may be met based on the inventory information and the vehicle information. In some aspects, the processor 246 determines that the predefined condition may be met when the connection with the inventory management unit 206 and/or the server(s) 204 may be lost (determined using the vehicle information) and/or when the vehicle 202 deviates by more than a predefined distance threshold from the preset delivery route (determined using the real-time geolocation and the inventory information).

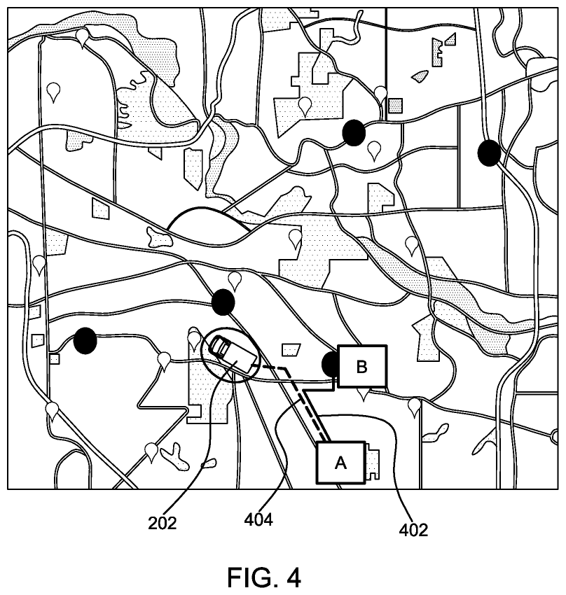

In an exemplary aspect, the vehicle 202 may disconnect with the inventory management unit 206 and/or the server(s) 204 when the vehicle 202 may be travelling in a geographical area where the network 210 may not be available or may be intermittent. Further, the vehicle 202 may deviate from the preset delivery route when the vehicle driver intentionally takes a different route (e.g., due to traffic or any other reason), or when the vehicle driver or the vehicle 202 unintentionally starts to traverse a different route. An example view of the vehicle 202 deviating from the preset delivery route is depicted in FIG. 4. As shown in FIG. 4, the vehicle 202 may deviate from a preset delivery route 402 from point “A” to a delivery location “B”, when the vehicle 202 begins to travel on a different route 404, as determined using the real-time vehicle geolocation.

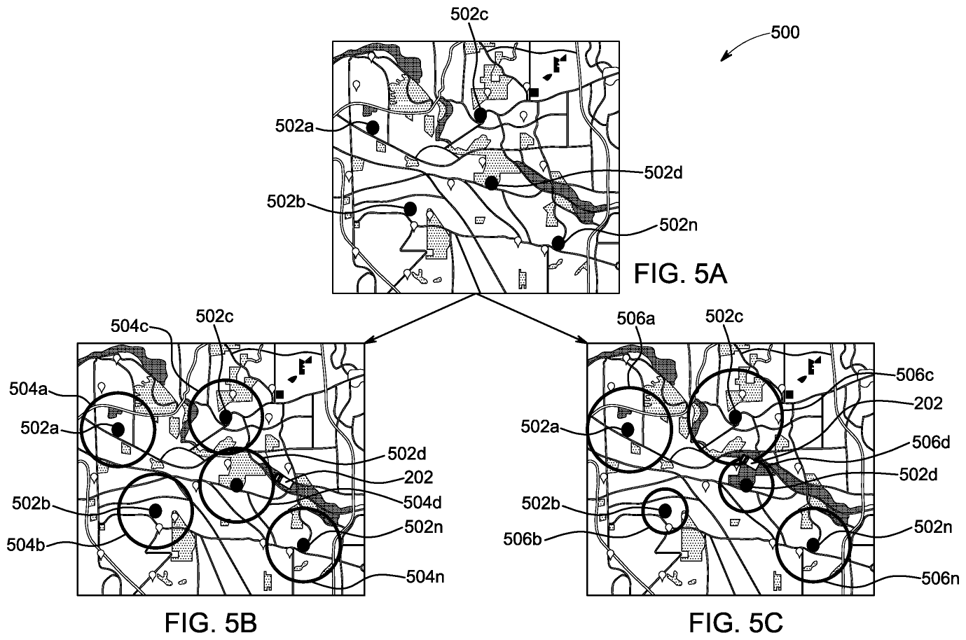

Responsive to determining that the predefined condition may be met as described above, the processor 246 may trigger the geofence mode of vehicle operation. Specifically, the processor 246 may determine, by executing the instructions stored in the inventory management module 250, the delivery status of each package 106 in the vehicle 202, respective delivery locations, bin storage locations of each package 106, location of each bin 104 in the vehicle 202, etc. based on the inventory information stored in the inventory database 254, responsive to triggering the geofence mode of vehicle operation. The processor 246 may further determine vehicle's distance from a current vehicle geolocation to the delivery locations associated with the packages 106, an average vehicle speed in the delivery route, and/or the like, based on the vehicle information obtained from the VCU 214/transceiver 244. Responsive to determining the information described above, the processor 246 may generate a geofence on a digital map for each delivery location/address based on the inventory information and the vehicle information. The process of generating the geofence may be understood in conjunction with the description of FIGS. 5A, 5B, 5C, 6 and 7 described above.

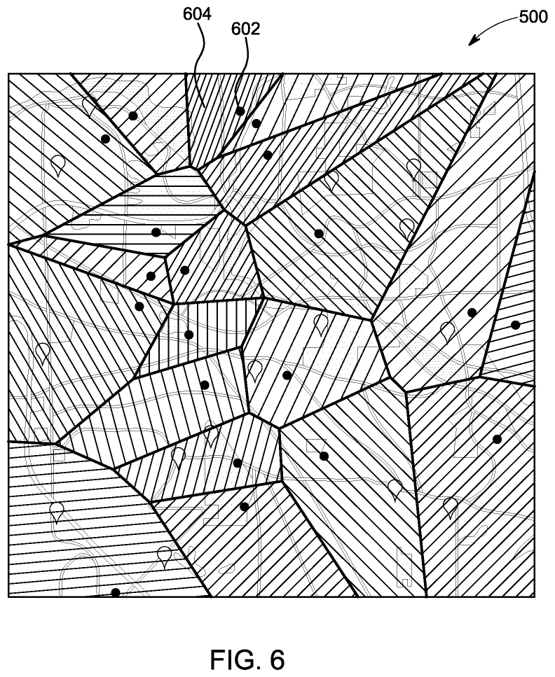

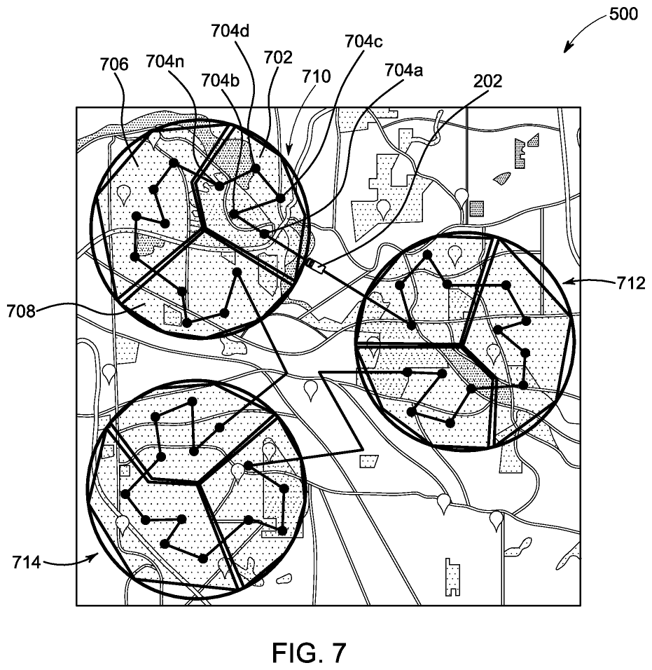

As shown in FIG. 5A, the processor 246 may initially determine one or more delivery addresses 502a, 502b, 502c, 502d, 502n associated with the packages 106 on a digital map of a geographical area 500 where the vehicle 202 may be located. Responsive to determining the delivery addresses 502a-n, the processor 246 may determine whether the delivery addresses 502a-n may be congested or uncongested. In some aspects, the processor 246 may determine that the delivery addresses 502a-n may be congested when distances between adjacent delivery addresses may be less than a predefined threshold (e.g., less than a mile). On the other hand, the processor 246 may determine that the delivery addresses 502a-n may be uncongested when distances between adjacent delivery addresses may be more than the predefined threshold. In some aspects, the processor 246 may generate different types of geofences for the delivery addresses 502a-n based on whether the delivery addresses 502a-n may be congested or uncongested. Stated another way, the processor 246 may generate the geofences for the delivery addresses 502a-n based on distances between adjacent delivery addresses. The process of generating geofences for uncongested delivery addresses 502a-n is described below in conjunction with FIGS. 5B and 5C, and the process for generating geofences for congested delivery addresses is described later in conjunction with FIGS. 6 and 7.

In an exemplary first aspect, when the delivery addresses 502a-n may be uncongested, the processor 246 may generate “circular” geofences of same radius for each delivery address 502a-n, as depicted in FIG. 5B. Specifically, the processor 246 may generate geofences 504a-n for respective delivery addresses 502a-n, and each geofence 504a-n may have same radius “R”. In some aspects, the processor 246 may determine the radius “R” based on the initial inventory information that may be provided by the inventory management unit 206 when the vehicle 202 commenced the pre-set delivery route (e.g., before or when the vehicle 202 left the warehouse 116 after getting the packages 106 loaded in the vehicle 202). In this case, the initial inventory information provided by the inventory management unit 206 may include the radius “R”, and the processor 246 may use the radius “R” to generate the geofences 504a-n when the processor 246 triggers the geofence mode of vehicle operation.

Responsive to generating the geofences 504a-n, the processor 246 may monitor the real-time vehicle geolocation and determine when the vehicle 202 enters one or more geofences 504a-n (e.g., the geofence 504d, as depicted in FIG. 5B). Specifically, the processor 246 monitors the distance between the real-time vehicle geolocation and the delivery address 502d, and determines that the vehicle 202 may have entered the geofence 504d when the distance becomes equivalent to the radius “R”. Responsive to determining that the vehicle 202 may have entered the geofence 504d, the processor 246 may perform a predefined action. Specifically, the processor 246 may execute the instructions stored in the inventory control module 252 to transmit a command signal and activate a package/bin mover unit (not shown) of the vehicle 202 when the vehicle 202 enters the geofence 504d. The package/bin mover unit may be a robot or a mechanical actuator disposed in the vehicle 202 that may be configured to move a package (e.g., the package 106) from a bin (e.g., the bin 104) or the bin 104 from a bin location in the vehicle 202 to the package unloading area 114. In this case, the processor 246 may transmit the command signal, including a bin location of the bin 104 that stores the package 106 whose delivery address is the delivery address 502d, to the package/bin mover unit when the vehicle 202 enters the geofence 504d. Responsive to receiving the command signal, the package/bin mover unit may move towards the bin location, pick the bin 104 or the package 106 from the bin 104, and move the bin104/package 106 to the package unloading area 114. By activating the package/bin mover unit a predefined distance (e.g., distance=radius “R”) before the vehicle 202 reaches the delivery address 502d, the processor 246 ensures that the bin 104/package 106 may be conveniently and timely moved to the package unloading area 114 by the time the vehicle 202 reaches the delivery address 502d.

In further aspects, the processor 246 may execute the instructions stored in the inventory control module 252 to cause the vehicle interior cameras to capture an image of the tag disposed on the package 106 when the package 106 may be picked (e.g., by the vehicle operator or robot/drone) from the package unloading area 114, and transmit the captured image to the processor 246. The processor 246 may “analyze” or read the image to determine that the package 106 may have been delivered to the delivery address 502d, and may execute the instructions stored in the inventory management module 250 to update the inventory information stored in the inventory database 254. The updated inventory information may then be stored in the inventory database 254.

In the exemplary first aspect described above, the inventory management unit 206 may estimate the radius “R” based on an average (historical) vehicle speed, an expected average time duration required by the package/bin mover unit to move the bins 104 from respective storage locations in the vehicle 202 to the package unloading area 114, and/or distances between adjacent delivery addresses 502a-n. For example, the radius “R” may be larger when the average vehicle speed may be high and/or when the average time duration required by the package/bin mover unit may also be high. In this case, by increasing the radius “R”, the inventory management unit 206 may provide additional time to the package/bin mover unit to move the bins 104 to the package unloading area 114. As another example, the radius “R” may be shorter when the average vehicle speed may be less and/or when the average time duration required by the package/bin mover unit may also be less. In some aspects, the radius “R” or dimensions of each geofence 504a-n may remain constant and same throughout the vehicle delivery route when the radius “R” may be provided by the inventory management unit 206 as part of the initial inventory information.

Although the description above describes an aspect where the radius “R” may be provided by the inventory management unit 206 as part of the initial inventory information, the present disclosure is not limited to the radius “R” being provided by the inventory management unit 206. In some aspects, the processor 246 may itself calculate the radius “R” and may generate the geofences 504a-n based on the average vehicle speed in the delivery route (determined based on the vehicle information), the average time duration required by the package/bin mover unit (determined using inputs obtained from the VCU 214), and/or distances between adjacent delivery addresses 502a-n (determined based on the inventory information), as described above. In this case, the processor 246 may not require the radius “R” as part of the initial inventory information.

Furthermore, although the description above describes an aspect where each geofence 504a-n has same dimensions (e.g., same radius “R”), the present disclosure is not limited to such geofence dimensions. In an exemplary second aspect, dimensions of each geofence may be customized or optimized for the corresponding delivery address, and may be different from other geofences. For example, based on a distance of a specific delivery address from other/adjacent delivery addresses and/or local parameters (e.g., traffic, expected or real-time vehicle speed, road conditions, etc.) in proximity to the specific delivery address, the geofence for the delivery address may have different dimensions from other geofences. An example view of such customized or “dynamic” geofences is depicted in FIG. 5C.

As shown in FIG. 5C, each geofence 506a-n associated with each delivery address 502a-n may have different dimensions. For example, the geofence 506d may have a smaller radius than a radius of the geofence 506c, as shown in FIG. 5C. In this case, the processor 246 may separately calculate radius of each geofence 506a-n based on real-time or expected vehicle speed in proximity to respective delivery addresses, time required by the package/bin mover unit to move respective bins/packages, distance from adjacent delivery addresses, and local parameters described above (that may be pre-stored in the memory 248 or obtained real-time from the VCU 214). Further, in this case, if the vehicle 202 enters an intersection of two geofences (e.g., the geofences 506c and 506d, as shown in FIG. 5C), the processor 246 may execute the instructions stored in the inventory control module 252 to activate the package/bin mover unit to move the package/bin associated with the delivery address 502c first, and then move the package/bin associated with the delivery address 502d. Stated another way, the processor 246 may prioritize bin/package movement associated with a smaller-radius geofence (e.g., the geofence 506c) over bin/package movement associated with a larger-radius geofence (e.g., the geofence 506d), when the vehicle 202 may be present in both geofences simultaneously.

Furthermore, in this case, the dimensions of each geofence 506a-n may not remain constant through the delivery route, and may change based on bin movement within the vehicle 202 when the packages 106 may be delivered to respective delivery locations. Specifically, as described above, the processor 246 may execute the instructions stored in the inventory management module 250 to update the inventory information as and when each package 106 may be delivered. While updating the inventory information, the processor 246 may also update bin location based on bin movement in the vehicle 202 when the packages 106 may be delivered on the delivery route. Responsive to updating the bin location, the processor 246 may update dimensions of each geofence 506a-n based on “updated” time required by the package/bin mover unit to move each bin 104 to the package unloading area 114. In some aspects, the processor 246 may dynamically update dimension of each geofence 506a-n after each package delivery. In other aspects, the processor 246 may dynamically update dimension of each geofence 506a-n after a preset time duration.

In an exemplary third aspect, the geofences may not be circular in shape, but may instead be of other shapes, as depicted in FIGS. 6 and 7. In some aspects, when the delivery addresses associated with the packages 106 may be congested (as shown in FIG. 6 with delivery addresses 602), the processor 246 may use, for example, Voronoi partitions, to generate polygonal geofences 604.

Each geofence 604 may be associated with one or more densely packed or closely located delivery addresses 602. Further, each geofence 604 may have a different shape that may be based on dimensions of a maximum permissible geographical area within a geofence (that may be pre-stored in the memory 248 and/or part of the initial inventory information provided by the inventory management unit 206), a maximum count of delivery addresses that may be located in a geofence, and/or the like.

In the exemplary aspect depicted in FIG. 6, each geofence 604 includes one delivery address 602. In another exemplary aspect depicted in FIG. 7, each geofence 702 may include a cluster of closely located multiple delivery addresses 704a-n. In some aspects, optimized clusters of closely located delivery addresses 704a-n may be pre-formed by the inventory management unit 206 before the vehicle 202 commences the delivery route and may be provided to the vehicle 202 as part of the initial inventory information (that may be stored in the memory 248). In this case, the processor 246 may fetch the pre-formed clusters of delivery addresses from the memory 248 when the processor 246 triggers the geofence mode of vehicle operation, and may generate the geofences 702, 706, 708, etc. based on the pre-formed clusters.

In other aspects, when the clusters may not be pre-formed by the inventory management unit 206, the processor 246 may itself form the clusters based on distances between the delivery addresses associated with the packages 106, and may then generate the geofences 702, 706, 708, etc. based on the formed clusters. In some aspects, the cluster size may be based on a maximum count of permissible delivery addresses in a cluster, and/or distances (or “closeness”) of adjacent delivery addresses. In some aspects, the processor 246 may additionally club adjacent geofences 702, 706, 708 to form super geofence clusters, shown as super geofence clusters 710, 712 and 714 in FIG. 7.

In the exemplary aspect depicted in FIG. 7, when the vehicle 202 enters the geofence 702, the processor 246 may execute the instructions stored in the inventory control module 252 to activate the package/bin mover unit to move bins/packages associated with the delivery addresses 704a. 704b, 704c, 704d, 704n sequentially to the package unloading area 114, so that the vehicle operator or robot/drone may conveniently pick the packages to be delivered in the order of delivery.

As described above, the processor 246 may update the inventory information stored in the inventory database 254 as and when the packages 106 may delivered on the delivery route. In addition, the processor 246 may continuously monitor the vehicle information obtained from the VCU 214/transceiver 244 to determine if the vehicle connection with the inventory management unit 206 may be restored. Responsive to a determination that the vehicle connection may have been restored, the processor 246 may transmit the “updated” inventory information, via the transceiver 244, to the inventory management unit 206. Responsive to receiving the updated inventory information, the inventory management unit 206 may transmit the updated inventory information to the server 204 for storage purpose, and may also begin to control vehicle and bin/package movement in the vehicle 202, as described above. Stated another way, the inventory management unit 206 may “takeover” bin/package movement control operation from the processor 246 when the vehicle connection may be restored.

In further aspects, when the vehicle 202 finishes traversing the delivery route, the vehicle 202 may return to the warehouse 116. When the vehicle 202 reaches the onboarding point 302, the infrastructure marshalling system 208 may determine an optimum unloading point 310a, 310b or 310c for the vehicle 202 and marshal the vehicle 202 the optimum unloading point, to enable the vehicle 202 to unload any undelivered packages 106. The process of determining the optimum unloading point and the parameters used by the infrastructure marshalling system 208 to determine the optimum unloading point are same the process/parameters described above for determining the optimum loading point, and hence are not described again here for the sake of simplicity and conciseness.

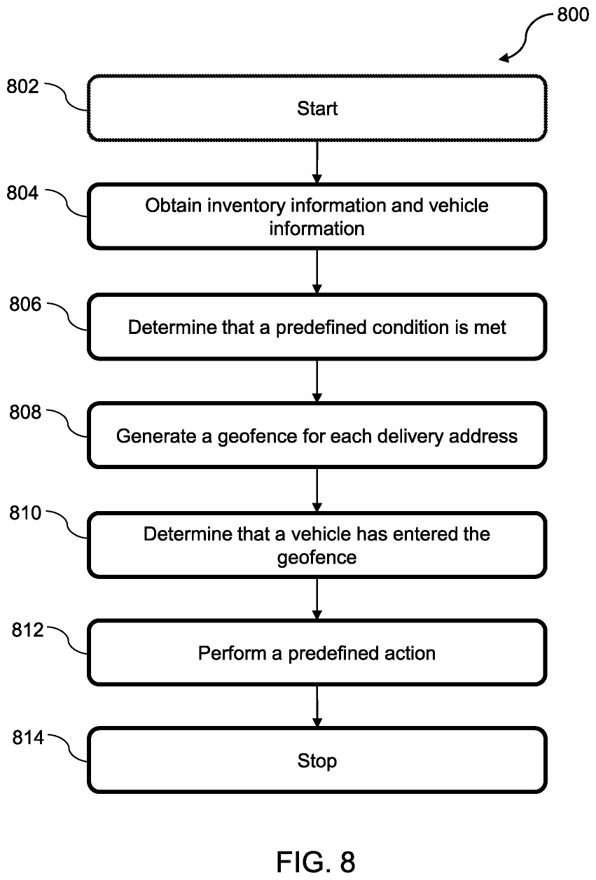

FIG. 8 depicts a flow diagram of an example method 800 for facilitating delivery of a plurality of packages stored in a delivery vehicle in accordance with the present disclosure. FIG. 8 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 800 starts at step 802. At step 804, the method 800 may include obtaining, by the processor 246, the inventory information and the vehicle information. At step 806, the method 800 may include determining, by the processor 246, that the predefined condition may be met based on the inventory information and the vehicle information. As described above, the processor 246 may determine that the predefined condition may be met when the vehicle connection with the inventory management unit 206 may be lost and/or when the vehicle 202 deviates from the preset delivery route.

At step 808, the method 800 may include generating, by the processor 246, a geofence for each delivery address, as described above. At step 810, the method 800 may include determining, by the processor 246, that the vehicle 202 may have entered the geofence based on the real-time vehicle geolocation. Responsive to determining that the vehicle 202 may have entered the geofence, the processor 246 may perform a predefined action at step 812. Specifically, the processor 246 may activate the package/bin mover unit to move a bin/package associated with the delivery address of the geofence to the package unloading area 114, as described above.

The method 800 ends at step 814.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a transceiver configured to receive inventory information associated with a plurality of packages from a server, wherein the inventory information comprises a plurality of delivery addresses associated with the plurality of packages;
a control unit configured to determine vehicle information; and
a processor communicatively coupled with the transceiver and the control unit, wherein the processor is configured to:
obtain the inventory information and the vehicle information;
determine that a predefined condition is met based on the inventory information and the vehicle information;
generate a geofence for each delivery address based on the vehicle information responsive to determining that the predefined condition is met;
determine that the vehicle has entered the geofence based on the vehicle information; and
perform a predefined action responsive to determining that the vehicle has entered the geofence.

2. The vehicle of claim 1, wherein the plurality of packages are stored in a plurality of bins, and wherein the plurality of bins are disposed in the vehicle.

3. The vehicle of claim 2, wherein the vehicle information comprises a vehicle geolocation, a vehicle speed and a connection status with the server when the vehicle travelling, and wherein the inventory information further comprises storage information of each package in the plurality of bins.

4. The vehicle of claim 3 further comprising:
a package unloading area; and
a bin mover unit configured to move a bin storing the package to the package unloading area.

5. The vehicle of claim 4, wherein the predefined action comprises activating the bin mover unit to move the bin to the package unloading area.

6. The vehicle of claim 4, wherein the processor is further configured to generate the geofence based on a time duration required by the bin mover unit to move the bin to the package unloading area.

7. The vehicle of claim 3, wherein the processor is further configured to generate the geofence based on an average vehicle speed on a vehicle delivery route, and wherein dimensions of each geofence of a plurality of geofences associated with the plurality of delivery addresses is same.

8. The vehicle of claim 3, wherein the inventory information further comprises a preset travel route for the vehicle.

9. The vehicle of claim 8, wherein the predefined condition is met when the vehicle deviates by more than a predefined distance threshold from the preset travel route.

10. The vehicle of claim 3 further comprising a memory configured to store the inventory information.

11. The vehicle of claim 10, when the predefined condition is met when the connection status indicates that a connection with the server is lost.

12. The vehicle of claim 11, wherein the processor is further configured to:
update the inventory information when a package, of the plurality of packages, is delivered; and
store an updated inventory information in the memory.

13. The vehicle of claim 12, wherein the processor is further configured to transmit the updated inventory information to the server when the connection with the server is restored.

14. The vehicle of claim 1, wherein the processor is further configured to generate the geofence for a delivery address based on a distance of the delivery address from an adjacent delivery address on a vehicle delivery route.

15. A method to facilitate delivery of a plurality of packages stored in a vehicle, the method comprising:
obtaining, by a processor, inventory information associated with the plurality of packages from a server, and vehicle information from a vehicle control unit, wherein the inventory information comprises a plurality of delivery addresses associated with the plurality of packages;
determining, by the processor, that a predefined condition is met based on the inventory information and the vehicle information;
generating, by the processor, a geofence for each delivery address based on the vehicle information responsive to determining that the predefined condition is met;
determining, by the processor, that the vehicle has entered the geofence based on the vehicle information; and
performing, by the processor, a predefined action responsive to determining that the vehicle has entered the geofence.

16. The method of claim 15, wherein the plurality of packages is stored in a plurality of bins, and wherein the plurality of bins is disposed in the vehicle.

17. The method of claim 16, wherein the vehicle information comprises a vehicle geolocation, a vehicle speed, and a connection status with the server when the vehicle travelling, and wherein the inventory information further comprises storage information of each package in the plurality of bins.

18. The method of claim 17, wherein performing the predefined action comprises causing movement of a bin storing the package to a package unloading area of the vehicle.

19. The method of claim 18, wherein generating the geofence comprises generating the geofence based on a time duration required to move the bin to the package unloading area.

20. A non-transitory computer-readable storage medium having instructions stored thereupon which, when executed by a processor, cause the processor to:
obtain inventory information associated with a plurality of packages from a server, and vehicle information from a vehicle control unit of a vehicle, wherein the inventory information comprises a plurality of delivery addresses associated with the plurality of packages;
determine that a predefined condition is met based on the inventory information and the vehicle information;
generate a geofence for each delivery address based on the vehicle information responsive to determining that the predefined condition is met;
determine that the vehicle has entered the geofence based on the vehicle information; and
perform a predefined action responsive to determining that the vehicle has entered the geofence.
